(19) United States
(12) Patent Application Publication
(10) Pub. No.: US 2024/0413995 A1
(43) Pub. Date: Dec. 12, 2024

(54) HIGH LEVEL SYNTHSIS OF CLOUD CRYPTOGRAPHY CIRCUITS

(71) Applicant: Microsoft Technology Licensing, LLC, Redmond, WA (US)

(72) Inventors: Mojtaba BISHEH NIASAR, Ithaca, NY (US); Bharat S. PILLILLI, El Dorado Hills, CA (US)

(21) Appl. No.: 18/207,016

(22) Filed: Jun. 7, 2023

(51) Int. Cl. H04L 9/32

(52) U.S. Cl. CPC H04L 9/32

(57) ABSTRACT

Generally discussed herein are devices, systems, and methods for high-level synthesis of a kyber cryptography circuit. A method can include defining, by a high-level programming language, behavior of a kyber cryptography circuit resulting in a behavior definition. The behavior of the kyber cryptography circuit can include parallel butterfly operations with output of the parallel butterfly operations fedback directly to inputs of the parallelized butterfly operations. The method can include converting, by high-level synthesis (HLS), the behavior definition to a gate-level implementation resulting in a circuit definition. The method can include implementing the circuit definition in hardware.

### BACKGROUND

The advent of quantum computers poses a serious challenge to the security of the existing public-key cryptosystems, as they can be potentially broken based on Shor's algorithm. Lattice-based cryptosystems are among the most promising post-quantum cryptography (PQC) algorithms that are believed to be hard for both classical and quantum computers to break.

### SUMMARY

A method, device, system, or a machine-readable medium for kyber cryptography circuit synthesis are provided. A method can include defining, by a high-level programming language, behavior of a kyber cryptography circuit resulting in a behavior definition, the behavior of the kyber cryptography circuit including parallel butterfly operations with output of the parallel butterfly operations fedback directly to inputs of the parallel butterfly operations. The method can include converting, by high-level synthesis (HLS), the behavior definition to a gate-level implementation resulting in a circuit definition. The method can include implementing the circuit definition in hardware.

The behavior definition can include a number of defined circuit operations that can include one or more of:
butterfly operations configurable as Cooley-Tukey (CT) butterfly operations or Gentleman-Sande (GS) butterfly operations;
before receiving the outputs, rearranging an order of the outputs to alter which of the butterfly operations receives one or more of the outputs;
one or more of number theoretic transform (NTT) and inverse number theoretic transform (INTT);
the butterfly operations as part of the NTT and the INTT;
polynomial multiplication in an NTT domain with a polynomial that has n coefficients and there are n/2 butterfly operations;
each butterfly operation receiving a first coefficient of a polynomial from a respective first register;
each butterfly operation receiving a second coefficient of the polynomial from a respective second register;
each butterfly operation receiving a twiddle factor from a respective third register;
selection, based on a select control, coefficients of a polynomial or the outputs of the butterfly operations; or
in each butterfly operation, a selection, based on a select control, whether the butterfly operation is in NTT mode or INTT mode.

A device, machine-readable medium, or system can be configured to implement the method.

### BRIEF DESCRIPTION OF DRAWINGS

FIG. 1 illustrates, by way of example, a conceptual circuit diagram of an embodiment of a Cooley-Tukey (CT) butterfly operator circuit.

FIG. 2 illustrates, by way of example, a conceptual circuit diagram of an embodiment of a Gentleman-Sande (GS) butterfly operator circuit.

FIG. 3 illustrates, by way of an example, a circuit diagram of a general purpose butterfly operator circuit.

FIG. 4 illustrates, by way of example, a diagram of an embodiment of an architecture for performing number theoretic transform (NTT)/inverse NTT (INTT) at a polynomial level and stage level.

FIG. 5 illustrates, by way of example, a diagram of an embodiment of a scalable NTT/INTT circuit.

FIG. 6 illustrates, by way of example, a diagram of an embodiment of a data flow for an NTT computation of an 8-point polynomial using CT butterfly operations.

FIG. 7 illustrates, by way of example, a graph 700 of implementation results of operations of the circuit for a polynomial of degree 256, i.e., n=256.

FIG. 8 illustrates, by way of example, a diagram of an embodiment of a Kyber architecture.

FIG. 9 illustrates, by way of example, a diagram of an embodiment of a system for efficiently generating a cryptography circuit.

FIG. 10 illustrates, by way of example, a diagram of a graph of throughput (operations per second) for three Kyber operations.

FIG. 11 illustrates, by way of example, a conceptual difference in field programmable gate array (FPGA) design flow using RTL and HLS methods.

FIG. 12 illustrates, by way of example, a block diagram of an embodiment of a method for kyber cryptography circuit synthesis.

FIG. 13 illustrates, by way of example, a block diagram of an embodiment of a machine (e.g., a computer system) to implement one or more embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the embodiments. It is to be understood that other embodiments may be utilized and that structural, logical, and/or electrical changes may be made without departing from the scope of the embodiments. The following description of embodiments is, therefore, not to be taken in a limited sense, and the scope of the embodiments is defined by the appended claims.

Cloud computing has become an integral part of modern society, offering various services and applications to individuals and organizations. The security of cloud computing is threatened by the advent of quantum computers, which can potentially break the existing public-key cryptosystems, such as Rivest-Shamir-Adleman (RSA) and Elliptic Curve Cryptography (ECC) based on Shor's algorithm. Shor's algorithm is a quantum computer algorithm for finding the prime factors of an integer. Current public-key cryptography is not presently threatened by modern quantum computers. However, the cloud resource managers should anticipate the challenge quantum computers pose to modern cryptography and initiate a transition to a postquantum era in a timely manner. In fact, the U.S. government issued a National Security Memorandum in May 2022 that mandated federal agencies to migrate to post-quantum cryptosystems (PQC) by 2035 to mitigate risks to vulnerable cryptographic systems.

The long-term security of cloud computing against quantum attacks can benefit from developing lattice-based cryptosystems, which are among the most promising PQC algorithms that are believed to be hard for both classical and quantum computers. The American National Institute of Standards and Technology (NIST) recognized this and selected CRYSTALS-KYBER and CRYSTALS-Dilithium, two lattice-based algorithms, as standards for post-quantum key-establishment and digital signatures, respectively, in July 2022. Lattice-based cryptography uses polynomial operations over a polynomial ring, which can be implemented efficiently using number theoretic transform (NTT) and inverse number theoretic transform (INTT). These transforms can reduce the computational complexity of polynomial multiplication. NTT-based multiplication, which has a long history of use in various applications, especially in signal processing, is also a performance challenge for lattice-based cryptography implementation.

CRYSTALS-Kyber, a key encapsulation mechanism (KEM), is based on module learning-with-errors problem (M-LWE) in module lattices. Kyber is notable for high-speed and constant-time implementations. As the next generation of the cryptosystem, Kyber will benefit from implementation and evaluation on various platforms and applications, especially for cloud computing, which demands high performance and security. However, Kyber frameworks have not received enough attention as potential cloud-deployable cryptography frameworks. Exploring the hardware design of Kyber is necessary to exploit the advantages of FPGA-based architectures, such as parallelism, which can improve the system performance in the cloud setting.

Hardware accelerators can be designed using two main approaches. RTL uses low-level languages such as Very High-Speed Integrated Circuit Hardware Description Language (VHDL) or Verilog to design a hardware architecture, which can offer more control and optimization. However, RTL requires a longer design time and a hand-optimized design that may sacrifice flexibility. On the other hand, high-level synthesis (HLS) uses high-level languages, which can offer flexibility and a shorter design cycle, but it may not achieve the best hardware efficiency.

Embodiments overcome difficulties of exploring and deploying Kyber cryptography frameworks in the cloud. Embodiments allow the HLS approach to be used to implement a pure hardware design of NTT and Kyber architecture accessible through the cloud, which can be faster and more flexible than other methods. HLS allows one to design a hardware architecture using high-level specifications, which can be mapped to field programmable gate array (FPGA) and application specific integrated circuit (ASIC) platforms with some optimizations. HLS also enables one to leverage the cloud resources to provide a scalable and secure environment for fast deploying a high-performance Kyber architecture.

Lattice-based cryptosystems are among the most promising PQC algorithms that are believed to be hard for both classical and quantum computers. NTT and INTT can be used to achieve more efficient polynomial multiplication in lattice-based cryptosystems. NTT and INTT help reduce algorithm complexity from O(n²) to O(n log n). Embodiments include a circuit architecture that can include multi-levels of parallelism. The parallelism helps accelerate the NTT/INTT computation on reconfigurable hardware. Embodiments allow a designer to explore different design spaces. Embodiments can allow a designer to explore trade-offs on hardware platforms for different NTT/INTT configurations. Embodiments can use one or more of various optimization techniques, including multi-levels of parallelism, designing reconfigurable cores, and implementing interleaved and pipelined architecture. Embodiments can achieve significant speedup as compared to prior NTT and INTT computation techniques. Embodiments can achieve the speedup while maintaining high security and scalability.

NTT and INTT operations can be accomplished iteratively. NTT and INTT can be performed by applying a sequence of “butterfly operations” on the input polynomial coefficients. Butterfly operations are arithmetic operations that combine two coefficients of polynomials to obtain two outputs. The NTT and INTT operations can be computed in a logarithmic number of steps using repeated butterfly operations.

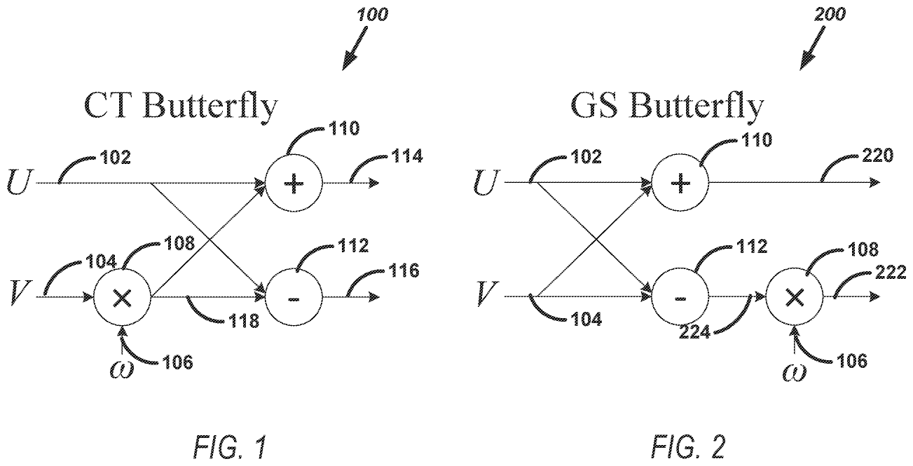

In embodiments, Cooley-Tukey (CT) and Gentleman-Sande (GS) butterfly configurations can be used to facilitate NTT/INTT computation. A commonly required bit-reverse function reverses the bits of the coefficient index. However, the bit-reverse permutation can be skipped by using CT butterfly operations for NTT and GS butterfly operations for INTT. FIGS. 1 and 2 illustrate a CT butterfly operator and the GS butterfly operator, respectively. More details regarding NTT/INTT and lattice-based computation of NTT/INTT are provided elsewhere herein.

FIG. 1 illustrates, by way of example, a conceptual circuit diagram of an embodiment of a CT butterfly operator circuit 100. The circuit 100 performs the CT butterfly operations. The circuit 100 takes, as input U 102 and V 104, which are coefficients of respective polynomials, and ω 106, which is a weight. V 104 and ω 106 are modular multiplied (V mod q*Ω)) using a multiplier 108. A result 118 of the multiplication performed by the multiplier 108 and U 102 are added using an adder 110 to generate a first output coefficient 114. The result 118 and U 102 are subtracted using a subtractor 112 to generate a second output coefficient 116. The first and second output coefficients 114 and 116 can then be used as inputs, U and V, respectively, in a next iteration of circuit 100 operation.

Pseudocode for an iterative NTT operation using the CT butterfly operator circuit 100 is provided:

In-Place NTT Algorithm using CT Butterfly Operator Circuit

| Require: α(x) ∈ R_{q}, ωₙ ∈ [symbol] _{q}, n = 2^{l} | |
|---|---|
| Ensure: \hat{α}(x) = NTT(α) ∈ R_{q} | |
| 1: | α ← bit − reverse(α) |
| 2: | for i from 1 to l do |
| 3: | m = 2^{l-i} |
| 4: | for j from 0 to 2ⁱ⁻¹−1 do |
| 5: | W ← ωₙ^{1+j} |
| 6: | for k from 0 to m−1 do |
| 7: | U ← \hat{α}[2jm + k] |
| 8: | V ← \hat{α}[2jm + k + m] mod q |
| 9: | T ← V · W |
| 10: | \hat{α}[2jm + k] = U + T mod q |
| 11: | \hat{α}[2jm + k + m] = U − T mod q |
| 12: | end for |
| 13: | end for |
| 14: | end for |
| 15: | return α(x) ∈ R_{q} |

where a is a polynomial and ω is a twiddle factor, and n is a number of coefficients in the polynomial.

FIG. 2 illustrates, by way of example, a conceptual circuit diagram of an embodiment of a GS butterfly operator circuit 200. The circuit 200 performs the mathematical operations the GS butterfly operation. The circuit 200 takes, as input U 102, V 104, and ω 106. U and V are added mod q, by modular adder 110, resulting in a first output coefficient 220. U 102 and V 104 are subtracted mod q, by modular subtractor 112, resulting in result 224. The result 224 is then multiplied by a weight, ω 106, using a modular multiplier 108. A result of the multiplication performed by the multiplier 108 is a second output coefficient 222. The first and second output coefficients 220 and 222 can then be used as inputs in a next iteration of circuit 200 operation.

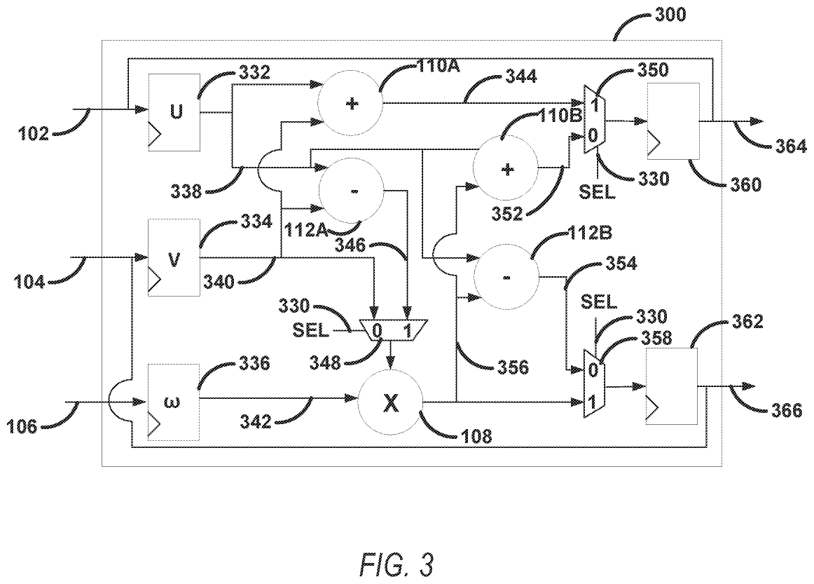

FIG. 3 illustrates, by way of example, a circuit diagram of a general purpose butterfly operator circuit 300. The circuit 300 can perform CT butterfly operations or GS butterfly operations based on the state of a select signal 330. The circuit 300 as illustrated includes modulo adders 110A, 110B, modulo subtractors 112A, 112B, registers 332, 334, 336, 360, 362, multiplexers 348, 350, 358, and a modulo multiplier 108. The circuit 300 while operating in CT mode is described interleaved with and followed by description of the circuit 300 while operating in GS mode.

When in CT mode, the select signal 330, in the example of FIG. 3, is set to zero (0). The logic of the select signal is not important and the select signal could equivocally be one (1) to place the circuit 300 into CT mode. In either CT or GS mode, registers 332, 334, 336 store U 102, V 104, and ω 106, respectively. On a next clock cycle, each of the registers 332, 334, 336 will provide new outputs (e.g., the coefficients 338, 340, and a twiddle factor 342, respectively), to the adder 110A, 110B, subtractor 112A, 112B, multiplexer 348, and multiplier 108. In CT mode, the adder 110A and the subtractor 112A are not relevant. Likewise, in GS mode, the adder 110B and the subtractor 112B are not relevant. Thus, the circuit 300 can be implemented with a single adder and a single subtractor. The circuit 300 is illustrated as including two adders and two subtractors, just for ease of understanding and ease of illustration.

In CT mode, the select signal 330 is zero. The multiplier 108 receives the output of the ω register 336 provides a relevant twiddle factor 342 to the multiplier 108. The multiplexer 348 provides output 340 of the register 334 to the multiplier 108. The multiplier 108 multiplies the inputs to produce result 356.

Adder 110B receives output 338 of the register 332 and the result 356. The adder 110B sums the output 338 and the result 356 and provides a result 352 to the multiplexer 350. The multiplexer 350 provides the result 352 to the output register 360. The output register 360 provides the result 352 as a first coefficient 364 during the next clock cycle.

The result 356 is subtracted, by subtractor 112B, from output 338 of the register 332. A result 354 of the subtraction is provided by multiplexer 358 to output register 362. The register 362 provides the result 354 as a second coefficient 366 during a next clock cycle.

In GS mode, the select signal 330 is one. The multiplier 108 receives the output of the ω register 336 which provides a relevant twiddle factor 342. The multiplexer 348 provides output 340 of the subtractor 112A to the multiplier 108. The subtractor 112A determines a difference between the output 338 of the register 332 and the output 340 of the register 334 as result 346. The multiplier 108 multiplies the inputs to produce result 356 which is different from the result when the circuit 300 is in CT mode.

Adder 110A receives output 338 of the register 332 and output 340 of the register 334. The adder 110A sums the outputs 338 and 340 and provides a result 344 to the multiplexer 350. The multiplexer 350 provides the result 344 to the output register 360. The output register 360 provides the result 344 as a first coefficient 364 during the next clock cycle.

The result 356 is provided by multiplexer 358 to output register 362. The register 362 provides the result 354 as a second coefficient 366 during a next clock cycle.

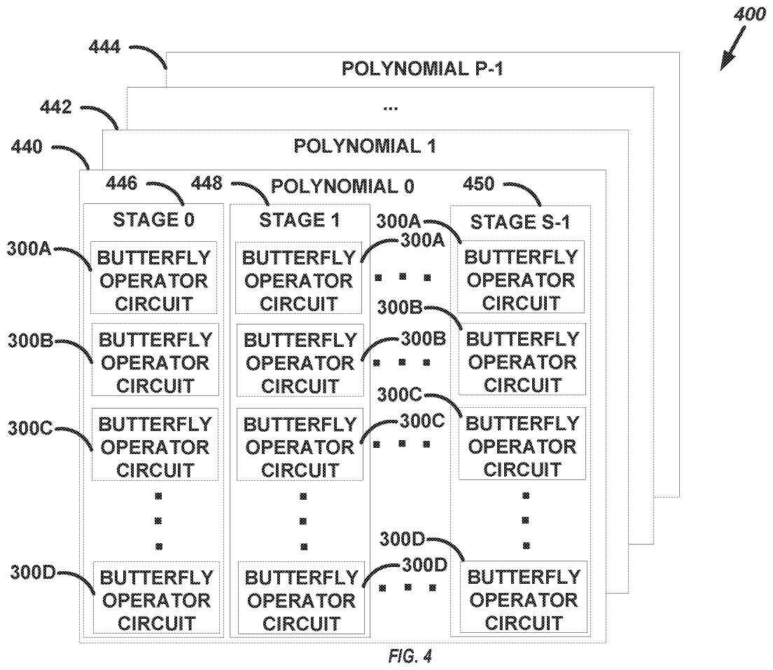

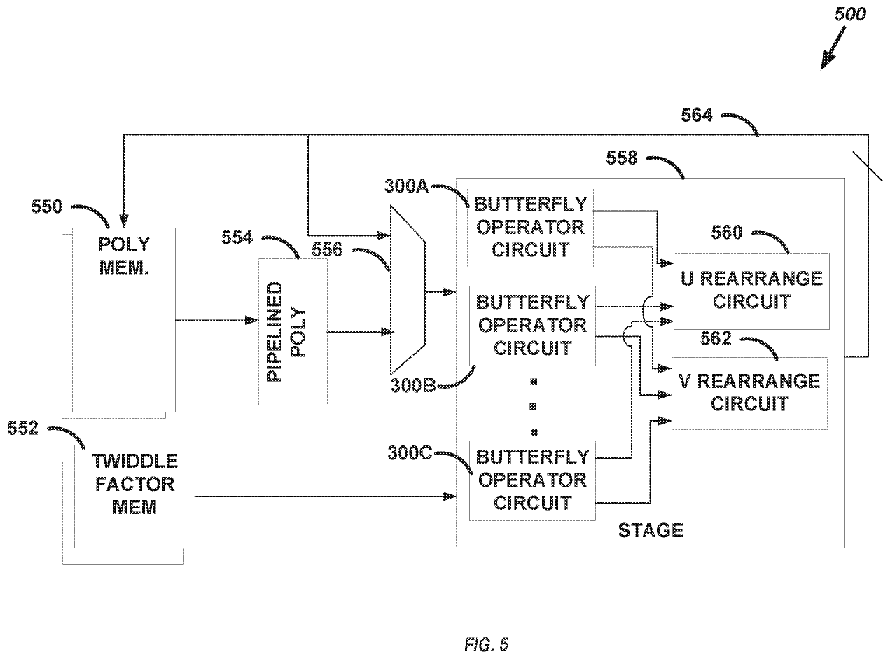

FIGS. 4 and 5 present further details of an architecture of a proposed NTT/INTT operator circuit. The architecture takes advantage of FPGA-based architectural designs exploiting the multi-level of parallelism. The parallel architecture ultimately leads to improvements in the performance and efficiency of the computation. As will be evident, the required NTT/INTT operations can be categorized into three levels, including butterfly core level, stage level, and polynomial level (from inner to outer), respectively. Embodiments can optimize computation at one or more of the levels with a different technique as follows:
1) Butterfly Core Level: A reconfigurable butterfly core (sometimes called a butterfly operator or a butterfly circuit or a butterfly operator circuit) is proposed to support both CT and GS operations, which are used for NTT and INTT, respectively, such as to employ resource-sharing techniques and avoid the bit-reverse cost in polynomial multiplication. To perform an NTT over a polynomial of degree n, n/2 independent butterfly operations per stage are performed. These butterfly operations can be performed in parallel to accelerate NTT operations; however, such parallel operations are challenging due to the memory access pattern, particularly, for resource-constrained platforms.

A circuit, illustrated in FIGS. 4 and 5 can be configured with a selectable number of butterfly operator circuits. This flexibility can be offered using a high level specification (HLS) technique. With this strategy, the user can configure the circuit to have a specified number of butterfly circuits 300. The user can thus be the decision-maker and consider trade-offs between the required resources and performance based on their target applications. The butterfly circuit 300 employs three registers corresponding to each required input and also buffers the results in two output registers. Hence, the latency of the butterfly circuit 300, represented by tcore, is 2 cycles.
2) Stage Level: The NTT computation of a polynomial of degree n includes log n stages of n/2 butterfly circuit 300 operations. The operation of n/2 butterfly circuits 300 provides n results since each butterfly circuit 300 provides 2 outputs. The number of stages is thus S=log n. Each of the stages uses output of the preceding stage as its input. Memory access to output of the previous result is thus an important potential bottleneck in stage level implementation. This is, at least in part because the memory access pattern varies for each stage. However, NTT has an aligned access pattern, which means the number of consecutive accesses to the polynomial remains constant.

FIG. 4 illustrates, by way of example, a diagram of an embodiment of an architecture 400 for performing NTT/INTT at a polynomial level 440, 442, 444 and stage level 446, 448, 450. There are P polynomials, where P is an integer, and S stages, where S is an integer, shown in FIG. 4. Assuming P has n coefficients, S=log n and the number of circuits 300A, 300B, 300C, 300D in each stage 446, 448, 450 is n/2.

The throughput of the stage level 446, 448, 450 is proportional to the number of butterfly circuits 300A, 300B, 300C, 300D. Let n_{core} be the number of implemented butterfly circuits 300A, 300B, 300C, 300D in the stage level 446, 448, 450. Given full utilization of butterfly cores, 2n_{core} coefficients are transformed in t_{core}.

The architecture 400 uses an interleaved stage architecture with parallel register banks embedded into the butterfly circuit 300. The parallel register banks help avoid memory access limitations during stage 446, 448, 450 setup operations. The registers 332, 334, 336 are illustrated in FIG. 3. Since all butterfly arithmetic is modular mod q, the total memory size to buffer these 2n_{core} coefficients in the stage architecture is 2n_{core}×log q bits. That amount is equal to the throughput of this level. Simultaneously, a reordering operation needs to be performed at the stage 446, 448, 450 level. A multiplexer structure (e.g., U rearrange circuit and V rearrange circuit) can be used to rearrange the coefficients and pass the coefficients to the next stage. However, these multiplexers result in increasing resource consumption due to the route and placement complexity of the design.

To reduce the required hardware resources, the stage 446, 448, 450 architecture can re-use the same butterfly circuits 300A, 300B, 300C, 300D in each stage 446, 448, 450. That is, the polynomial coefficients can be fed into butterfly circuits 300A, 300B, 300C, 300D in the first stage 446. The results from the first stage 446 are fed as input into the second stage 448, and so on until the final stage produces results that will be stored. Eq. 5 shows the required latency, t_{stage}, for each stage iteration:

$${t}_{stage} = n * \frac{{t}_{core}}{2 {n}_{core}}$$

The computation of an NTT takes t_{NTT} time to complete:

$${t}_{NTT} = {n}_{stage} \times {t}_{stage} = n * log n * \frac{{t}_{core}}{2 {n}_{core}}$$

FIG. 4 illustrates the NTT/INTT operation circuit at a polynomial level. Most lattice-based applications require performing NTT/INTT computation of a vector/matrix of polynomials. The NTT/INTT operations for each polynomial can be performed independently. While most existing implementations use an iterative process to compute an n_{poly} number of polynomials, embodiments can use a pipelined architecture to enhance the architecture, such as from a utilization factor perspective. Using the pipelined design ensures utilization of the stage architecture by feeding coefficients of a next polynomial at the last stage of the previous one. Hence, NTT computation of n_{poly} polynomials can be performed in time, t_{poly}, as:

$${t}_{poly} = {n}_{poly} \times {t}_{NTT} = {n}_{poly} * n * log n * {t}_{core} / 2 {n}_{core}$$

FIG. 5 illustrates, by way of example, a diagram of an embodiment of a scalable NTT/INTT circuit 500. The circuit 500 as illustrated includes a stage 558, which is an example of one of the stages 446, 448, 450 and is illustrated in more detail than in FIG. 4. The stage 558 is re-used in each iteration of determining coefficients for a polynomial in NTT domain or for determining the inverse coefficients in performing an INTT operation. The circuit 500 as illustrated includes a polynomial memory 550, a twiddle factor memory 552, a pipelined polynomial circuit 554, a multiplexer 556, and the stage 558.

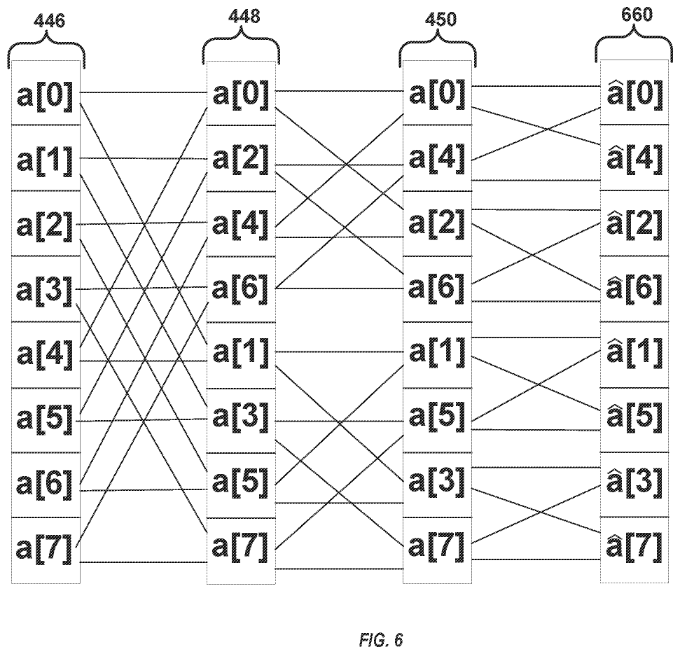

The polynomial memory 550 stores coefficients of polynomials to be converted to the NTT domain and converted back from the NTT domain. The pipelined polynomial circuit 554 includes circuitry to organize input from the polynomial memory 550. The pipelined polynomial circuit 554 organizes the input so that the butterfly operator circuits 300A, 300B, 300C receive the correct input coefficients. The pipeline polynomial circuit 554 provides the relevant coefficients to the multiplexer 556. See FIG. 6 for an explanation of the polynomial coefficient order. The multiplexer 556 selects either output 564 of a prior iteration or output of the pipelined polynomial circuit 554 as input to the stage 558. The output of the pipelined polynomial circuit 554 is provided in a first iteration of a given NTT conversion operation and the output 564 of the stage 558 is provided in the remaining iterations of the given NTT conversion until the final coefficients are determined. Assuming i number of iterations, the output of pipeline polynomial circuit 554 is provided for i=1 and the output 564 of the stage 558 is provided for iterations [2, . . . , i].

The twiddle factor memory 552 provides the proper twiddle fact, ω, for each butterfly operator circuit 300A, 300B, 300C. The butterfly operator circuits 300A, 300B, 300C are described regarding FIG. 3. Output from the butterfly operator circuits 300A, 300B, 300C are rearranged by U rearrange circuit 560 and V rearrange circuit 562. Each of the rearrange circuits 560, 562 include multiplexers, switches, or the like configured to alter an order of the coefficients produced by the stage 558. The rearrange circuits 560, 562 can organize the coefficients so that the butterfly operator circuits 300A, 300B, 300C receive the coefficients in proper order to compute the NTT.

What follows is a description of NTT/INTT. Let q be a prime number and [symbol] _{q} be the ring of integers modulo q. Define the ring of polynomials for some integer N as R_{q}= [symbol] _{q}[X]/(X^{N}+1), where the polynomials have n coefficients, each modulo q. Regular font lowercase letters (a) represent single polynomials, bold lowercase letters (a) represent polynomial vectors, and bold uppercase letters (A) to represent a matrix of polynomials. Representations in the NTT domain are represented by (â), (â) and (Â), respectively. Let a and b be polynomial vectors in R_{q}. Let a∘b∈R_{q} denote coefficient-wise multiplication of polynomials. The product of a matrix and a vector is the natural extension of coefficient-wise multiplication of the polynomial vectors.

A naive method of polynomial multiplication has O(n²) complexity. This complexity can be reduced by using NTT. To multiply two polynomials efficiently in lattice-based cryptography, the polynomial rings of the form R_{q}= [symbol] _{q}[X]/(X^{N}+1) can be used, where (X^{N}+1) enables fast polynomial division. The NTT transform maps polynomials to the NTT domain at the cost of O(n*log n) where multiplying their coefficients results in a polynomial that corresponds to the product of the original polynomials modulo q and (X^{N}+1). Coefficient-wise multiplication has a complexity of O(n). A total time complexity is thus O(n·log n).

The NTT is a generalization of a fast Fourier transform (FFT) defined in a finite field. Suppose f is a polynomial of degree n with coefficients in [symbol] _{q}, as:

$$f = {\sum }_{i = 0}^{n - 1} {f}_{i} {X}^{i}$$

FFT uses the twiddle factor ωₙ n-th root of unity of form e^{2πj/n}, while NTT has ωₙ∈ [symbol] _{q} such that ωₙ be a primitive n-th root of unity modulo q, i.e. ωₙⁿ=1 mod q. The NTT transforms f , i.e., \hat{f}=NTT(f ), is computed as follows for each i∈{0, 1, . . . , n−1}:

$${\hat{f}}_{i} = {\sum }_{j = 0}^{n - 1} {f}_{j} {ω}_{n}^{ij}$$

The INTT recovers f from \hat{f} as:

$${f}_{i} = {\sum }_{j = 0}^{n - 1} {\hat{f}}_{j} {ω}_{n}^{- ij}$$

Hence, the multiplication between two polynomials f and g using NTT can be performed as:

$$f . g = INTT ( NTT ( f ) ∘ NTT ( g ) )$$

NTT algorithm is shown in pseudocode elsewhere herein.

FIG. 6 illustrates, by way of example, a diagram of an embodiment of a data flow for an NTT computation of an 8-point polynomial using CT butterfly operations. The multiplexers of the U rearrange circuit 5?? and the V rearrange circuit 5?? handle the data flow between iterative operations performed by each stage. At a first stage 446, the 8 coefficients are provided. Four butterfly circuits 300 can operate in parallel on the 8 coefficients. In a first stage 446, a first butterfly circuit receives a least significant coefficient (constant or [a[0] or the first coefficient) and a fifth coefficient (a[4], the coefficient of x⁴ in the polynomial) and produces the least significant coefficient (the 1^{st} coefficient) and the second least significant coefficient (the 2^{nd} coefficient, a[1]) for a next stage 448. In the first stage 446, the second butterfly circuit receives the second coefficient (a[1]) and a sixth coefficient (a[5], the coefficient of x⁵ in the polynomial) and produces the third coefficient (a[2]) and the fourth coefficient (a[4]) for the next stage 448. In the first stage 446, the third butterfly circuit receives the third coefficient (a[2]) and a seventh coefficient (a[6], the coefficient of x⁶ in the polynomial) and produces the fifth coefficient (a[4]) and the fourth coefficient (a[5]) for the next stage 448. In the first stage 448, the fourth butterfly circuit receives the fourth coefficient (a[3]) and an eighth coefficient (a[7], the coefficient of x⁷ in the polynomial) and produces the seventh coefficient (a[6]) and the eighth coefficient (a[7]) for the next stage 448. Three more stages operate to generate the final coefficients 660 that represent the polynomial with coefficients a[i] in the NTT domain.

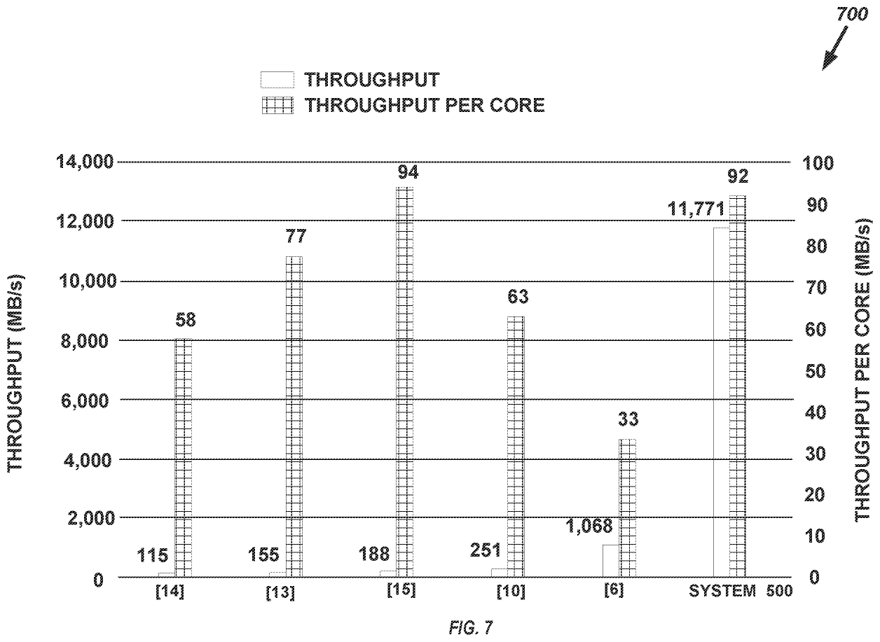

FIG. 7 illustrates, by way of example, a graph 700 of implementation results of operations of the circuit 500 for a polynomial of degree 256, i.e., n=256. To have a fair comparison, the performance is reported in terms of throughput in MB/s to consider different data path widths. The number of cores, n_{core}=128, for the graph results. With this implementation t_{stage}=2 cycles. Hence, an NTT computation takes only 14 cycles, i.e., t_{NTT}=14 cycles.

FIG. 7 shows the NTT architecture of FIG. 5 achieves a throughput of 11,771 MB/s using 128 butterfly circuits, while each circuit provides 92 MB/s on average. The proposed HLS-based butterfly circuit performance results are comparable to the hand-optimized core proposed in V. B. Dang, K. Mohajerani, and K. Gaj, “High-speed hardware architectures and FPGA benchmarking of crystals-kyber, ntru, and saber,” IEEE Trans. Computers, vol. 72, no. 2, pp. 306-320, 2023. (sometimes referred to as “[15]”), while outperforming other architectures in M. Bisheh-Niasar, R. Azarderakhsh, and M. M. Kermani, “High-speed ntt-based polynomial multiplication accelerator for post-quantum cryptography,” in 28th IEEE Symposium on Computer Arithmetic, ARITH 2021 Lyngby, Denmark, June 14-16, 2021, pp. 94-101, IEEE, 2021 (sometimes referred to as “[10]”); M. Bisheh-Niasar, R. Azarderakhsh, and M. M. Kermani, “Instruction set accelerated implementation of crystals-kyber,” IEEE Trans. Circuits Syst. I Regul. Pap., vol. 68, no. 11, pp. 4648-4659, 2021 (“M. Bisheh-Niasar et al”) (sometimes referred to as “[13]”), and Y. Xing and S. Li, “A compact hardware implementation of cca-secure key exchange mechanism CRYSTALS-KYBER on FPGA,” IACR Trans. Cryptogr. Hardw. Embed. Syst., vol. 2021, no. 2, pp. 328-356, 2021 (sometimes referred to as “[14]”). Compared to HLS-based NTT design in A. C. Mert, E. Karabulut, E. O\ddot{ }ztu\ddot{ }rk, E. Savas, and A. Aysu, “An extensive study of flexible design methods for the number theoretic transform,” IEEE Trans. Computers, vol. 71, no. 11, pp. 2829-2843, 2022 (sometimes referred to as “[6]”) embodiments can achieve almost 3× speedup per butterfly circuit.

Taking advantage of an optimized and scalable NTT architecture with multi-level parallelism, embodiments show a significant improvement. Embodiments can achieve 11× more throughput at the cost of around 4× resources compared to Mert et al. Hence, our architecture approximately improves 63% efficiency for NTT computation. For hand-optimized RTL design, the most high-performance design is presented by Bisheh-Niasar et. al. [10] in with a merged NTT layer, while embodiments outperform that design by almost 46× speedup.

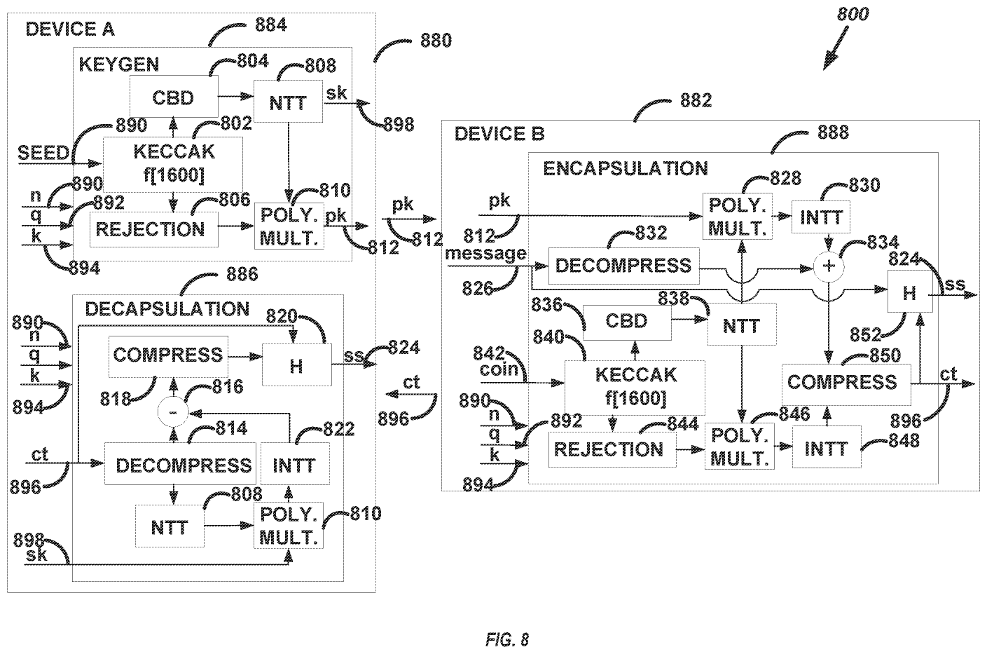

FIG. 8 illustrates, by way of example, a diagram of an embodiment of a Kyber architecture 800. Kyber is a key encapsulation method (KEM) designed to be resistant to cryptanalytic attacks with quantum computers. Kyber is used to establish a shared secret (ss 824) between two communicating parties without an indistinguishability under adaptive chosen ciphertext attack (IND-CCA2) attacker in the transmission system being able to decrypt the ss. Kyber is an asymmetric cryptosystem that uses a variant of a learning with errors lattice problem as its basic trapdoor function. Kyber won the National Industry of Standards and Technology (NIST) competition for the first post-quantum cryptography (PQC) standard. Only some details of Kyber operation are provided herein, for more details on Kyber operations see J. W. Bos, L. Ducas, E. Kiltz, T. Lepoint, V. Lyubashevsky, J. M. Schanck, P. Schwabe, G. Seiler, and D. Stehl'e, “CRYSTALS-kyber: A cca-secure module-lattice-based KEM,” in 2018 IEEE European Symposium on Security and Privacy, EuroS&P 2018, London, United Kingdom, Apr. 24-26, 2018, pp. 353-367, IEEE, 2018, available at https://eprint.iacr.org/2017/634, last accessed May 24, 2023.

As mentioned, Kyber is an IND-CCA2-secure key encapsulation scheme that has three principal functions: key generation (“keygen”), encryption (“encapsulation”), and decryption (“decapsulation”). The Kyber function samples a seed, s, from B, and A from U during keygen, where B and U are binomial and uniform distributions, respectively. Keygen computes the public key pk as pk=A·s+e in the NTT domain, where e is noise. In encryption, Kyber encodes m as a polynomial and samples r from B. The encryption function computes v=pk·r+m and u=A·r in the normal domain. Then, the encryption function compresses u and v to form ciphertext ct. In decryption, Kyber decompresses u and v and decodes m from v−sk·u in the NTT domain.

All polynomials in Kyber have 256 coefficients over k-dimensional vectors and prime modulus q=3329, where k=2, 3, 4 denotes the three security levels, including Kyber-512 with 128-bit security, Kyber-768 with 192-bit security, and Kyber-1024 with 256-bit security. Kyber uses these polynomial functions to construct a CPA-secure PKE scheme and applies a modified Fujisaki-Okamoto transformation to obtain a chosen-ciphertext attack (CCA)-secure KEM.

A coefficient-wise multiplication in Kyber includes 128 modular polynomial multiplications of degree 2, such that:

(â₂ᵢ+â₂ᵢ₊₁X)·(\hat{b}₂ᵢ+\hat{b}₂ᵢ₊₁X)=(â₂ᵢ\hat{b}₂ᵢ+â₂ᵢ₊₁\hat{b}₂ᵢ₊₁\hat{ω}ₙ^{2br}^{₇}⁽ⁱ⁾⁺¹)+(â₂ᵢ\hat{b}₂ᵢ+â₂ᵢ₊₁\hat{b}₂ᵢ₊₁)X mod(X²−\hat{ω}ₙ^{2br}^{₇}⁽ⁱ⁾⁺¹),

where br₇ is a bit reversal function.

The functionality of Kyber can be broken down into higher-level units, each of which can be implemented using High Level Synthesis (HLS).

HLS is an automated design process that takes an abstract behavioral specification of a digital system and finds a register-transfer level structure that realizes the given behavior. Synthesis begins with a high-level specification of the problem, where behavior is generally decoupled from low-level circuit mechanics such as clock-level timing. Program code, such as can be generated in a variety of programming languages, is used to generate the high-level specification of the behavior. The code is analyzed, architecturally constrained, and scheduled to transcompile from a transaction-level model (TLM) into a register-transfer level (RTL) design in a hardware description language (HDL), which is in turn commonly synthesized to the gate level by the use of a logic synthesis tool.

A goal of HLS is to help hardware designers efficiently build and verify hardware, by giving them better control over optimization of their design architecture, and through the nature of allowing the designer to describe the design at a higher level of abstraction while the tool does the RTL implementation. Verification of the RTL is an important part of the process.

Hardware can be designed at varying levels of abstraction. The commonly used levels of abstraction are gate level, register-transfer level (RTL), and algorithmic level. While logic synthesis uses an RTL description of the design, high-level synthesis works at a higher level of abstraction, starting with an algorithmic description in a high-level language such as SystemC and ANSI C/C++. The designer typically develops the module functionality and the interconnect protocol. The high-level synthesis tools handle the micro-architecture and transform untimed or partially timed functional code into fully timed RTL implementations, automatically creating cycle-by-cycle detail for hardware implementation. The (RTL) implementations are then used directly in a conventional logic synthesis flow to create a gate-level implementation.

The architecture 800 can be implemented using HLS. The Kyber architecture 800 shows a data flow indicated by arrows. The architecture 800 illustrated in FIG. 8 includes multiple devices 880 and 882, but can be implemented in a single device. Typically, a first device, such as the device 880 performs key generation to generate a secret key (sk) 898 and a public key (pk) 812, using keygen circuit 884. A second device, such as the device 882 receives the pk 812 and generates cypher text (ct) 896 using an encapsulation circuit 888 that operates based on the pk 812. The first device then decapsulates the ct 896 using a decapsulation circuit 886 and the sk 898

This architecture 800 includes NTT operator circuits 808 and 838, INTT operator circuits 822, 830, and 848, coefficient-wise polynomial multiplier 810, 828, and 848, Keccak-f[1600] 802 and 840, binomial centered distribution (CBD) 804 and 836, rejection sampler 806 and 844, and compress units 818 and 850, decompress units 814 and 832, adder 834, and subtractor 816. The INTT operator circuit 822 can be implemented using the same hardware that implements the NTT operator circuit 808 with a select control 330 (see FIG. 3) set to a different bit. Due to the similarity of required computation in Keygen 884, Encapsulation 888, and Decapsulation circuits 886 operations, only one set of NTT/INTT transform circuits can be implemented to support all these three operations. Using these operations, Alice (a user of the device 880) and Bob (a user of the device 882) can generate a shared secret key, shown by ss 824. Based on Kyber specification, four different configurations of Keccak are implemented, including Secure Hash Algorithm (SHA)3-256, SHA3-512, SHA and Keccak (SHAKE)-128, and SHAKE-256. These functions are implemented using a configurable Keccak core 802 and 840 providing 1600-bit output in 24 cycles in 64-bit data width.

The NTT operator circuits are discussed elsewhere, such as with regard to FIGS. 3-6 can be embedded into the architecture 800 as the NTT circuits 808 and 838 and INTT circuits 822, 830, and 848, such as to speed up Kyber computation. Since the number of butterfly circuits 300 (see FIG. 3) is configurable, the performance of Kyber can be adjusted based on the application requirement. For example, one can implement two different parameter sets for the NTT core, i.e., ncore=64, 128. Furthermore, to speed up the polynomial multiplication in the case of Kyber computation, one can perform NTT separately for odd and even coefficients due to the Kyber NTT definition.

The keygen circuit 884 receives a seed 889, n 890, q 892, and k 894. The seed 889 is a random number (sometimes called a pseudorandom number). The seed 889 can be generated using a random number generator. The seed 889 can be generated by sampling a uniform distribution. n 890 is the degree of the polynomial to be multiplied in the NTT domain, k indicates the security level to be implemented by Keccak circuit 802 and 840, and q is a prime number. Note each coefficient of the polynomial is determined modulo q. k also indicates a dimension of the coefficients of the polynomial.

The Keccak circuit 802 hashes the seed 890 using the hash function indicated by k 894. For example, if k=1 the Keccak circuit 802 can implement SHA3-256, if k=2 the Keccak circuit 802 can implement SHA3-512, if k=3 the Keccak circuit 802 can implement SHAKE-128, and if k=4 the Keccak circuit 802 can implement SHAKE-256.

The CBD 804 samples a binomial distribution centered based on a hash value generated by the Keccak circuit 802. The sample is a polynomial that is transformed to the NTT domain by the NTT circuit 808. The rejection sampler 806 also generates a polynomial based on the hash value from the Keccak circuit 802. The polynomials from the NTT circuit 808 and the rejection sampler 806 are multiplied (in the NTT domain) by the polynomial multiplier 810. The result of the multiplication is a private key 812.

The encapsulation circuit 888 receives n 890, q 892, and k 894, a compressed message 826, a coin 842, and the pk 812. The seed 889 is a random number (sometimes called a pseudorandom number). Keccak circuit 840 operates to generate a hash value based on the coin 842. The CBD circuit 836, rejection sampler 844, NTT circuit 838, and polynomial multipliers 846, 828 operate similar to the CBD circuit 804, the rejection sampler 806, NTT circuit 808, and polynomial multiplier 810, respectively, with different inputs. The INTT circuits 830, 848 operate to transform the inputs thereto to their original domain. An adder 834 sums an output of a decompress operation 832 and the INTT circuit 830. A compress circuit 850 compresses the result of the adder 834 and the output of the INTT circuit 848, to generate cyphertext, ct 896. The compressed message 826 and the cyphertext 896 are concatenated, by concatenator 852, to generate a shared secret, ss 824.

The ss 824 can be verified by the decapsulation circuit 886. The decapsulation circuit 886 receives n 890, q 892, and k 894, ct 896, and the sk 898. The decompress circuit 814 reverses the operations of the compress circuit 850. The result of the decompression performed by the decompress circuit 814 is provided to the NTT circuit 808. The polynomial generated by the NTT circuit 808 is multiplied by the sk 898 in the NTT domain by the polynomial multiplier 810. The INTT circuit 822 transforms the result of the polynomial multiplier 810 out of the NTT domain. A subtractor 816 determines a difference between the decompressed cyphertext provided by the decompress circuit 814 and the output of the INTT circuit 822. A result of the subtractor 816 is compressed, resulting in the compressed message 826. The compressed message 826 and the ct 896 are concatenated by a concatenate circuit 820 resulting in the same shared secret 824 as that generated by the encapsulation circuit 888. After verification, the devices 882 and 880 can now encrypt or decrypt based on the ss 824.

The kyber circuit 800 implementation was described using an HLS language and converted into hardware specification using an RTL. Results of implementing the kyber circuit 800 are compared with implementation results of other approaches and architectures in Table 1.

TABLE 1
Implementation of a Kyber-512 Architecture Compared with Other Works

| | | | | Freq. | KeyGen | Encaps | Decaps |
|---|---|---|---|---|---|---|---|
| Work | Platform | Design | Resources | [MHz] | [CCs] | [CCs] | [CCs] |
| [12] | Virtex-7 | HLS | 1,977,896 | 67 | — | 31669 | 43018 |
| | | | LUTs/194,126 FFs | | | | |
| [14] | Artix-7 | RTL | 7,412 LUTs/4,644 | 161 | 3768 | 5079 | 6668 |
| | | | FFs/2126 Slices/2 | | | | |
| | | | DSPs/3 BRAMs | | | | |
| [13] | Artix-7 | RTL | 18,000 LUTs/5,000 | 1616 | 4000 | 7000 | 10000 |
| | | | FFs/6 DSPs/15 | | | | |
| | | | BRAMs | | | | |
| [15] | Artix-7 | RTL | 9,347 LUTs/8,186 | 220 | 2100 | 3300 | 4500 |
| | | | FFs/4 DSPs/6 | | | | |
| | | | BRAMs | | | | |
| [10] | Artix-7 | RTL | 10,502 LUTs/9,859 | 200 | 1882 | 2446 | 3754 |
| | | | FFs/3,457 Slices/ | | | | |
| | | | 8 DSPs/13 BRAMs | | | | |
| Circuit | Stratix- | HLS | 204,474 ALUTs/ | 241 | 1793 | 2904 | 3973 |
| 800 | 10 | | 118,654 ALMs/78 | | | | |
| | | | DSPs/1,860 M20Ks | | | | |

Table I lists the detailed resource consumption and performance results for Kyber-512. As used herein, [12] refers to K. Basu, D. Soni, M. Nabeel, and R. Karri, “NIST post-quantum cryptography-A hardware evaluation study,” IACR Cryptol. ePrint Arch., p. 47, 2019 and the remaining references are provided previously.

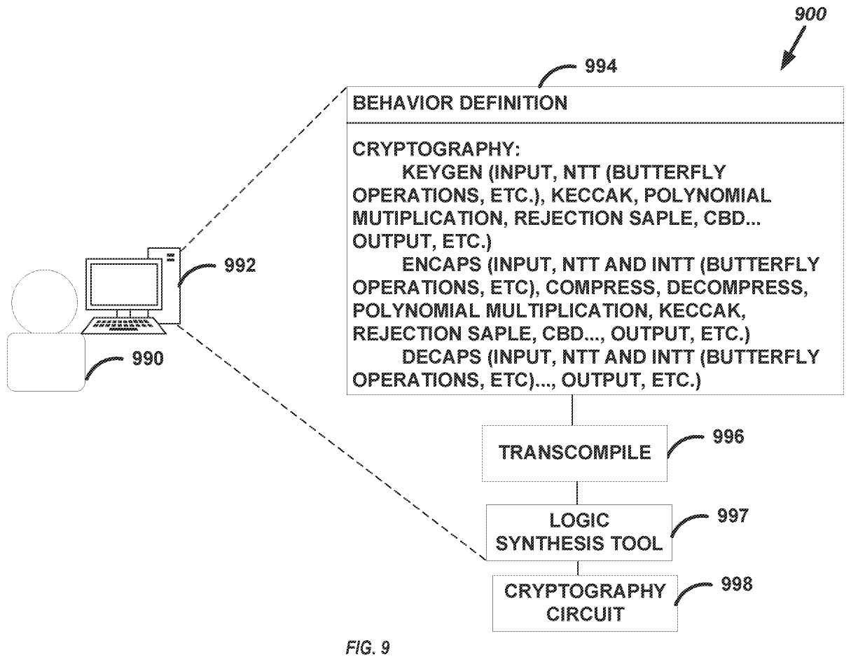

FIG. 9 illustrates, by way of example, a diagram of an embodiment of a system 900 for efficiently generating a cryptography circuit 998. The system 900 can help efficiently deploy and test a circuit for cloud or other operation. The system 900 includes a developer 990. The developer 990 writes program code through a user interface of a computer 992. The program code can be in any of a number of programming languages that provide high level synthesis (HLS) functionality. Such programming languages are called transaction level model languages (TLML). The program code is used as a behavior definition 994, sometimes called a transaction level model (TLM). The behavior definition 994 provides a detailed description of the functionality of a cryptography circuit 998, such as can include any of the circuits discussed herein. The behavior definition 994 is provided as input to a transcompiler 996. The transcompiler 996 is similar to a compiler that converts program code into an executable, with the transcompiler 996 converting the program code from a TLM into a register-transfer level (RTL) design in a hardware description language (HDL). The RTL is then synthesized into a gate level circuit description using a logic synthesis tool 997. The gate level description is then converted the cryptography circuit 998 on an application specific integrated circuit (ASIC), field programmable gate array (FPGA), or the like.

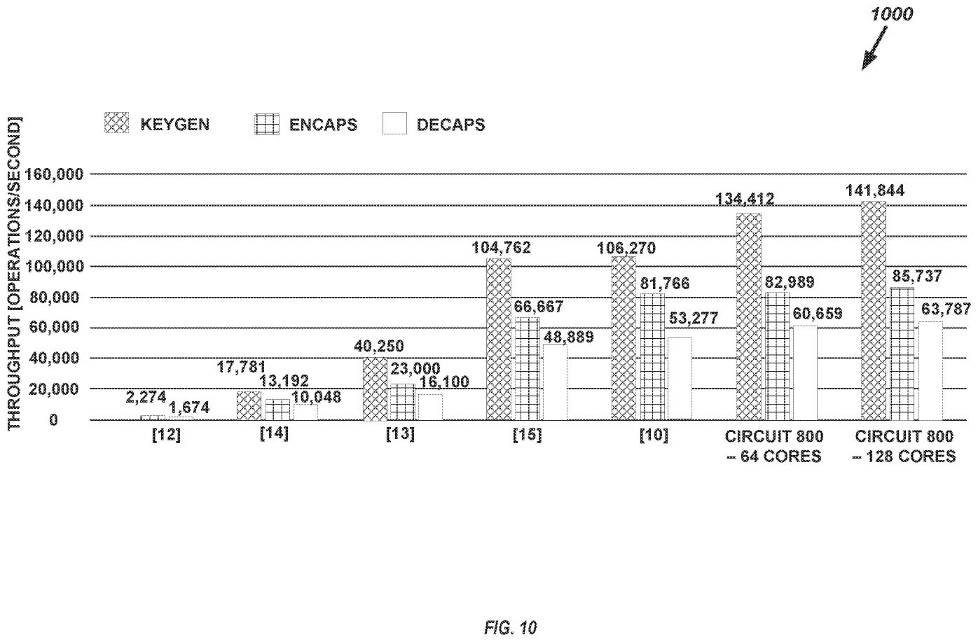

FIG. 10 illustrates, by way of example, a diagram of a graph 1000 of throughput (operations per second) for three Kyber operations. The Kyber operations include keygen, encapsulation, and decapsulation. FIG. 10 provides a visualization of performance results and comparison to state-of-the-art implementations in terms of the number of operations executed per second. The system 900 design employing 64 butterfly cores performs Keygen, Encaps, and Decaps operations in 7.4, 12.0, and 16.4 us, respectively. By increasing the number of cores to 128 butterfly cores, these operations take 7.0, 11.6, and 15.6 us, respectively.

As the number of utilized butterfly cores increases from 64 to 128, the latency improves around 3-6% at the expense of more hardware resources. This result also presents an analysis of the trade-off between resource consumption and time performance for scaling the butterfly cores. The results shown in FIG. 10 indicate that scaling the butterfly cores to a higher number reduces an NTT operation time but increases the hardware resource usage The trade-off desired by a given individual will vary depending on application constraints, such as a time-criticality and resource availability. The work in [10] presents a high-speed architecture of Kyber using 4 butterfly cores in 2×2 arrangement using a hand-optimized RTL method. The design in [10] performs 32,258 KEMs per second, including Encaps and Decaps operations assuming Keygen is performed offline. The system 800 implemented using HLS to design the Kyber architecture with 128 cores executes 36,575 KEMs per second while improving the performance by 33%, 5%, and 20% for Keygen, Encaps, and Decaps operations, respectively. However, this improvement is achieved at the cost of significant resource consumption due to using the HLS method.

Next, a detailed comparison with other HLS implementations is presented, followed by a discussion about the design effort and complexity of our scalable design compared to manual RTL coding. Although the system 800 requires more resources compared to [10]. [15], and [13], we list the resource and performance results of Basu et. al. [12] as another HLS-based design to have a better comparison. As one can see, the required resources in terms of LUT and FF are reduced, while the performance is improved by a factor of 38× compared to Basu. Note that each logic in Artix-7 and Virtex-7 slice contains four 6-input LUTs and eight flip-flops. However, each ALM contains a variety of LUT-based resources that can be divided between two combinational adaptive LUTs (ALUTs), a two-bit full adder, and four registers.

HLS uses more resources and generates a circuit architecture that includes more electrical and electronic components than manual RTL coding, especially for complex designs that involve memory access. However, HLS also offers some advantages such as faster development time, a higher level of abstraction, and easier verification.

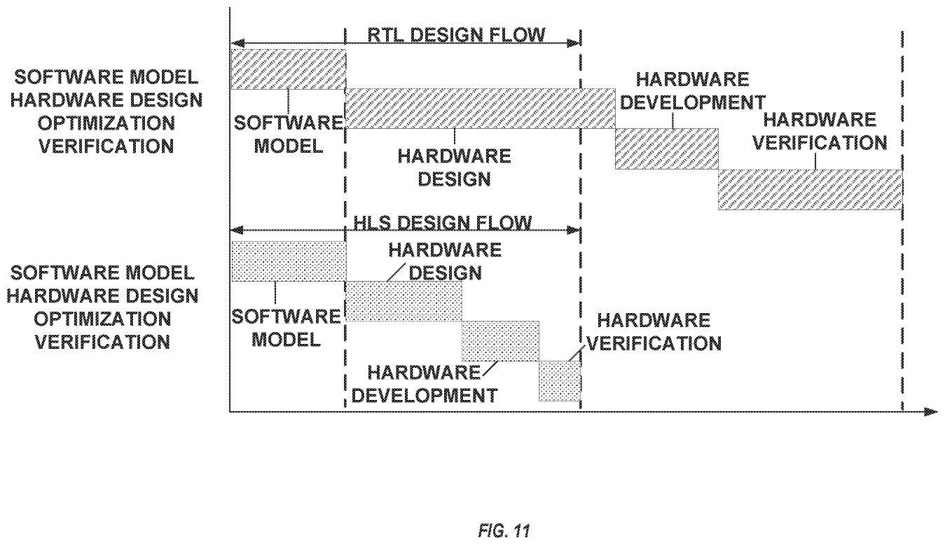

FIG. 11 illustrates, by way of example, a conceptual difference in field programmable gate array (FPGA) design flow using RTL and HLS methods. Although the software model is an independent process from the implementation method, HLS can significantly reduce the required time for the hardware design, development, and verification processes. HLS also provides more flexibility to have a scalable architecture. For example, changing the butterfly cores in NTT operation is very challenging in manual RTL coding. This is, at least in part, because the change requires a redesign of the memory structure and the control unit of the NTT architecture. However, HLS provides a flexible NTT generator design that takes a few minutes to adjust the parameters and synthesize the design with a desired parameter set.

Table 2 reports a development time of the Kyber system 800 with the NTT circuit 300 and the NTT circuit 300 independently in terms of man-hours. Mert et. al. in [6] also list the required time for three different development methods, including manual RTL design, RISC-Vbased architecture, and HLS. As one can see, HLS takes less time to develop, i.e., 60-80 less man-hours, to explore different optimizations and provide a parametric design framework.

TABLE 2
Design Effort and Complexity Results of the System
800 and Comparison with Prior Architectures

| | | Man | |
|---|---|---|---|
| Architecture | Design Method | Hours | Considerations |
| NTT | Manual RTL | 450 | Suffers from re-design |
| | Design [6] | | requirement for the |
| | | | memory structure and the |
| | | | control unit for changing |
| | | | polynomial degree and |
| | | | the coefficient size |
| | RISC-V [6] | 290 | Long environment setup |
| | | | process to build the |
| | | | RISC-V tool-chains and |
| | | | simulation environment, |
| | | | and limitation of the |
| | | | software platform |
| | HLS [6] | 60 | Limited capacities for |
| | | | exploring larger design |
| | | | space due to memory |
| | | | partitioning issue |
| | | | (manual memory |
| | | | partitioning may be |
| | | | required) |
| | Circuit 300 | 80 | Provided a unique degree |
| | | | of flexibility that can |
| | | | be readily adjusted |
| | | | for various applications |
| | | | for large-scale deployment |
| | | | of privacy-preserving |
| | | | computation in clouds |
| Kyber | Manual RTL | 410 | Used 2 butterfly cores |
| | Design [13] | | |
| | Manual RTL | 550 | Used 4 butterfly cores |
| | Design [10] | | |
| | System 800 | 320 | Scalable number of |
| | | | butterfly cores |

However, as mentioned in [6], their framework had a limited capacity to explore design space with more than 8 cores, or when the polynomial has a degree greater than 1,024. We also report the design effort for developing an entire Kyber architecture supporting all KEM operations. The authors in [10] and [13] provided us with their development time. As one can see, the Kyber design with 2 butterfly cores takes 410 manhours However, by increasing the number of cores to 4, the design is more complex and takes 550 man-hours. In contrast, our scalable design takes 320 man-hours providing flexibility to users for the trade-offs between the required resources and performance.

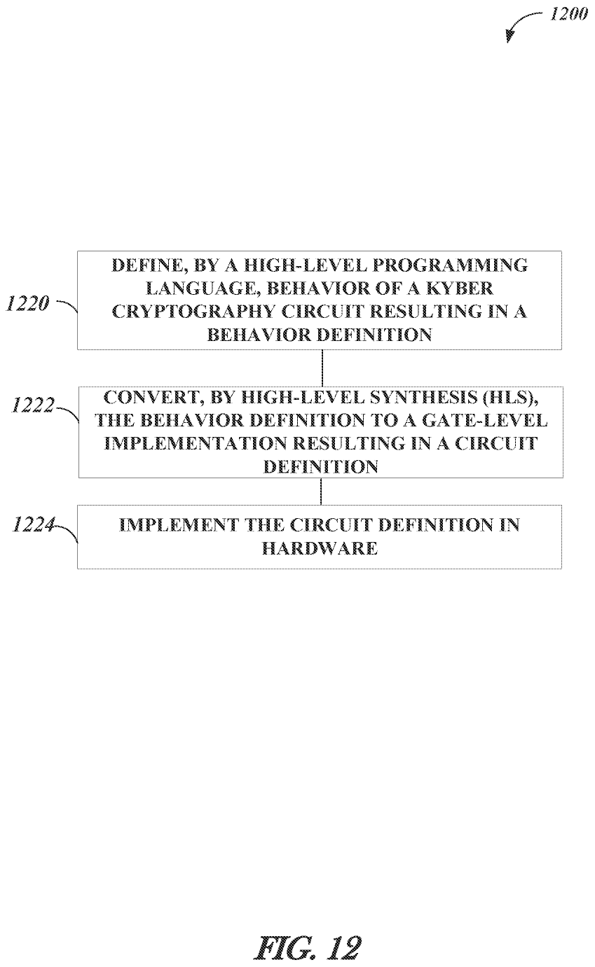

FIG. 12 illustrates, by way of example, a block diagram of an embodiment of a method 1200 for high-level synthesis of a kyber cryptography circuit. The method 1200 as illustrated includes defining, by a high-level programming language, behavior of a kyber cryptography circuit resulting in a behavior definition, at operation 1220; converting, by high-level synthesis (HLS), the behavior definition to a gate-level implementation resulting in a circuit definition, at operation 1222; and implementing the circuit definition in hardware, at operation 1224.

The behavior of the kyber cryptography circuit can include parallel butterfly operations with output of the parallel butterfly operations fedback directly to inputs of the parallel butterfly operations. The behavior definition can include the butterfly operations configured as Cooley-Tukey (CT) butterfly operations or Gentleman-Sande (GS) butterfly operations. The behavior definition can further include before receiving the outputs, rearranging an order of the outputs to alter which of the butterfly operations receives one or more of the outputs. The behavior definition can further include number theoretic transform (NTT) and inverse number theoretic transform (INTT). The behavior definition can further include the butterfly operations as part of the NTT and the INTT. The behavior definition can further include polynomial multiplication in an NTT domain with a polynomial that has n coefficients and there are n/2 butterfly operations. The behavior definition can further include each butterfly operation receiving a first coefficient of a polynomial from a respective first register, a second coefficient of the polynomial from a respective second register, and a twiddle factor of the from a respective third register. The behavior definition includes selection, based on a select control, coefficients of a polynomial or the outputs of the butterfly operations. The behavior definition includes, in each butterfly operation, a selection, based on a select control, whether the butterfly operation is in NTT mode or INTT mode.

Embodiments include an HLS approach to design a pure hardware NTT architecture, accessible over the cloud. The NTT architecture offers more speed and flexibility than prior approaches. HLS enables one to use high-level imperative programming to design a hardware architecture that can be optimized and mapped to FPGA and application specific integrated circuit (ASIC) platforms. Embodiments allow a scalable NTT architecture that can be leveraged to develop a high-performance Kyber architecture targeting cloud services. Embodiments tackle the challenges of performance, complexity, and design time by introducing a new framework for PQC cloudization. Our framework aims to design and implement a scalable and highly parallel framework based on NTT/INTT that can speed up lattice-based PQC algorithms, such as Kyber KEM. Results show that embodiments can achieve up to 11× speedup compared to existing NTT architectures while keeping high security and scalability. The implementations proposed include constant-time by design.

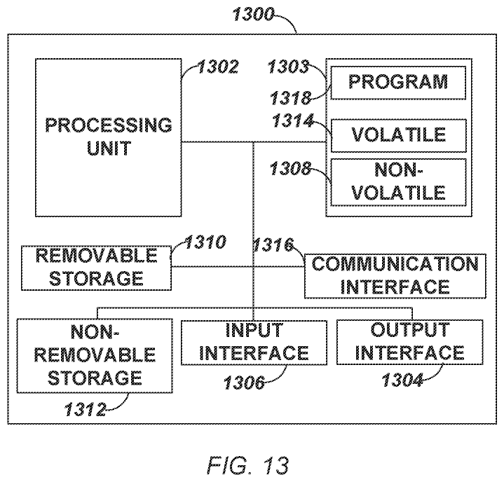

FIG. 13 illustrates, by way of example, a block diagram of an embodiment of a machine 1300 (e.g., a computer system) to implement one or more embodiments. The machine 1300 can implement a technique for kyber cryptography circuit synthesis. Any of the CT butterfly operator circuit 100, GS butterfly operator circuit 200, configurable butterfly operator circuit 300, stage 446, 448, 450, polynomial memory 550, twiddle factor memory 552, pipelined polynomial circuit 554, multiplexer 556, stage 558, rearrange circuit 560, 562, device 880, 882, keygen circuit 884, encapsulation circuit 888, decapsulation circuit 886, behavior definition 994, transcompiler 996, logic synthesis tool 997, cryptography circuit 998, method 1200 or a component or operation thereof can include one or more of the components of the machine 1300. One or more of the CT butterfly operator circuit 100, GS butterfly operator circuit 200, configurable butterfly operator circuit 300, stage 446, 448, 450, polynomial memory 550, twiddle factor memory 552, pipelined polynomial circuit 554, multiplexer 556, stage 558, rearrange circuit 560, 562, device 880, 882, keygen circuit 884, encapsulation circuit 888, decapsulation circuit 886, behavior definition 994, transcompiler 996, logic synthesis tool 997, cryptography circuit 998, method 1200, or a component or operations thereof can be implemented, at least in part, using a component of the machine 1300. One example machine 1300 (in the form of a computer), may include a processing unit 1302, memory 1303, removable storage 1310, and non-removable storage 1312. Although the example computing device is illustrated and described as machine 1300, the computing device may be in different forms in different embodiments. For example, the computing device may instead be a smartphone, a tablet, smartwatch, or other computing device including the same or similar elements as illustrated and described regarding FIG. 13. Devices such as smartphones, tablets, and smartwatches are generally collectively referred to as mobile devices. Further, although the various data storage elements are illustrated as part of the machine 1300, the storage may also or alternatively include cloud-based storage accessible via a network, such as the Internet.

Memory 1303 may include volatile memory 1314 and non-volatile memory 1308. The machine 1300 may include—or have access to a computing environment that includes—a variety of computer-readable media, such as volatile memory 1314 and non-volatile memory 1308, removable storage 1310 and non-removable storage 1312. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices capable of storing computer-readable instructions for execution to perform functions described herein.

The machine 1300 may include or have access to a computing environment that includes input 1306, output 1304, and a communication connection 1316. Output 1304 may include a display device, such as a touchscreen, that also may serve as an input device. The input 1306 may include one or more of a touchscreen, touchpad, mouse, keyboard, camera, one or more device-specific buttons, one or more sensors integrated within or coupled via wired or wireless data connections to the machine 1300, and other input devices. The computer may operate in a networked environment using a communication connection to connect to one or more remote computers, such as database servers, including cloud-based servers and storage. The remote computer may include a personal computer (PC), server, router, network PC, a peer device or other common network node, or the like. The communication connection may include a Local Area Network (LAN), a Wide Area Network (WAN), cellular, Institute of Electrical and Electronics Engineers (IEEE) 802.11 (Wi-Fi), Bluetooth, or other networks.

Computer-readable instructions stored on a computer-readable storage device are executable by the processing unit 1302 (sometimes called processing circuitry) of the machine 1300. A hard drive, CD-ROM, and RAM are some examples of articles including a non-transitory computer-readable medium such as a storage device. For example, a computer program 1318 may be used to cause processing unit 1302 to perform one or more methods or algorithms described herein.

The operations, functions, or algorithms described herein may be implemented in software in some embodiments. The software may include computer executable instructions stored on computer or other machine-readable media or storage device, such as one or more non-transitory memories (e.g., a non-transitory machine-readable medium) or other type of hardware based storage devices, either local or networked. Further, such functions may correspond to subsystems, which may be software, hardware, firmware, or a combination thereof. Multiple functions may be performed in one or more subsystems as desired, and the embodiments described are merely examples. The software may be executed on a digital signal processor, ASIC, microprocessor, central processing unit (CPU), graphics processing unit (GPU), field programmable gate array (FPGA), or other type of processor operating on a computer system, such as a personal computer, server or other computer system, turning such computer system into a specifically programmed machine. The functions or algorithms may be implemented using processing circuitry, such as may include electric and/or electronic components (e.g., one or more transistors, resistors, capacitors, inductors, amplifiers, modulators, demodulators, antennas, radios, regulators, diodes, oscillators, multiplexers, logic gates, buffers, caches, memories, GPUs, CPUs, field programmable gate arrays (FPGAs), or the like).

### Additional Notes and Examples

Example 1 includes a method comprising defining, by a high-level programming language, behavior of a kyber cryptography circuit resulting in a behavior definition, the behavior of the kyber cryptography circuit including parallel butterfly operations with output of the parallel butterfly operations fedback directly to inputs of the parallel butterfly operations, converting, by high-level synthesis (HLS), the behavior definition to a gate-level implementation resulting in a circuit definition, and implementing the circuit definition in hardware.

In Example 2, Example 1 can further include, wherein the behavior definition includes the butterfly operations configured as Cooley-Tukey (CT) butterfly operations or Gentleman-Sande (GS) butterfly operations.

In Example 3, at least one of Examples 1-2 further includes, wherein the behavior definition further comprises before receiving the outputs, rearranging an order of the outputs to alter which of the butterfly operations receives one or more of the outputs.

In Example 4, at least one of Examples 1-3 further includes, wherein the behavior definition includes number theoretic transform (NTT) and inverse number theoretic transform (INTT).

In Example 5, Example 4 further includes, wherein the behavior definition includes the butterfly operations as part of the NTT and the INTT.

In Example 6, Example 5 further includes, wherein the behavior definition includes polynomial multiplication in an NTT domain with a polynomial that has n coefficients and there are n/2 butterfly operations.

In Example 7, at least one of Examples 1-6 further includes, wherein the behavior definition includes each butterfly operation receiving a first coefficient of from a respective first register, a second coefficient from a respective second register, and a twiddle factor of the from a respective third register.

In Example 8, Example 7 further includes, wherein the behavior definition includes selection, based on a select control, coefficients of a polynomial or the outputs of the butterfly operations.

In Example 9, at least one of Examples 3-8 further includes, wherein the behavior definition includes, in each butterfly operation, a selection, based on a select control, whether the butterfly operation is in NTT mode or INTT mode.

Example 10 includes a system comprising a user interface configured to receive data defining, by a high-level programming language, behavior of a kyber cryptography circuit resulting in a behavior definition, the behavior of the kyber cryptography circuit including parallel butterfly operations with output of the parallel butterfly operations fedback directly to inputs of the parallelized butterfly operations, a transcompiler configured to convert the behavior definition to a gate-level implementation resulting in a circuit definition, and a logic synthesis tool configured to implement the circuit definition in hardware.

In Example 11, Example 10 can further include, wherein the behavior definition includes the butterfly operations configured as Cooley-Tukey (CT) butterfly operations or Gentleman-Sande (GS) butterfly operations.

In Example 12, at least one of Examples 10-11 can further include, wherein the behavior definition further comprises before receiving the outputs, rearranging an order of the outputs to alter which of the butterfly operations receives one or more of the outputs.

In Example 13, at least one of Examples 10-12 further includes, wherein the behavior definition includes number theoretic transform (NTT) and inverse number theoretic transform (INTT).

In Example 14, Example 13 further includes, wherein the behavior definition includes the butterfly operations as part of the NTT and the INTT.

In Example 15, Example 14 further includes, wherein the behavior definition includes polynomial multiplication in an NTT domain with a polynomial that has n coefficients and there are n/2 butterfly operations.

In Example 16, at least one of Examples 10-15 further includes, wherein the behavior definition includes each butterfly operation receiving a first coefficient of from a respective first register, a second coefficient from a respective second register, and a twiddle factor of the from a respective third register.

In Example 17, Example 16 further includes, wherein the behavior definition includes selection, based on a select control, coefficients of a polynomial or the outputs of the butterfly operations.

In Example 18, at least one of Examples 12-17 further includes, wherein the behavior definition includes, in each butterfly operation, a selection, based on a select control, whether the butterfly operation is in NTT mode or INTT mode.

Example 19 includes a non-transitory machine-readable medium including instructions that, when executed by a machine, cause the machine to perform operations comprising receiving, by a high-level programming language, a behavior definition of a kyber cryptography circuit, the behavior definition including parallel butterfly operations with output of the parallel butterfly operations fedback directly to inputs of the parallelized butterfly operations, converting, by high-level synthesis (HLS), the behavior definition to a gate-level implementation resulting in a circuit definition, and synthesizing the circuit definition in hardware.

In Example 20, Example 19 further includes, wherein the behavior definition includes polynomial multiplication in an NTT domain with a polynomial that has n coefficients and there are n/2 butterfly operations.

In Example 21, Example 19 further includes one or more of the operations of the method of one or more of Examples 3-9.

Although a few embodiments have been described in detail above, other modifications are possible. For example, the logic flows depicted in the figures do not require the order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. A method comprising:
defining, by a high-level programming language, behavior of a kyber cryptography circuit resulting in a behavior definition, the behavior of the kyber cryptography circuit including parallel butterfly operations with output of the parallel butterfly operations fedback directly to inputs of the parallel butterfly operations;
converting, by high-level synthesis (HLS), the behavior definition to a gate-level implementation resulting in a circuit definition; and
implementing the circuit definition in hardware.

2. The method of claim 1, wherein the behavior definition includes the butterfly operations configured as Cooley-Tukey (CT) butterfly operations or Gentleman-Sande (GS) butterfly operations.

3. The method of claim 1, wherein the behavior definition further comprises before receiving the outputs, rearranging an order of the outputs to alter which of the butterfly operations receives one or more of the outputs.

4. The method of claim 1, wherein the behavior definition includes number theoretic transform (NTT) and inverse number theoretic transform (INTT).

5. The method of claim 4, wherein the behavior definition includes the butterfly operations as part of the NTT and the INTT.

6. The method of claim 5, wherein the behavior definition includes polynomial multiplication in an NTT domain with a polynomial that has n coefficients and there are n/2 butterfly operations.

7. The method of claim 1, wherein the behavior definition includes each butterfly operation receiving a first coefficient of a polynomial from a respective first register, a second coefficient of the polynomial from a respective second register, and a twiddle factor from a respective third register.

8. The method of claim 7, wherein the behavior definition includes selection, based on a select control, coefficients of a polynomial or the outputs of the butterfly operations.

9. The method of claim 3, wherein the behavior definition includes, in each butterfly operation, a selection, based on a select control, whether the butterfly operation is in NTT mode or INTT mode.

10. A system comprising:
a user interface configured to receive data defining, by a high-level programming language, behavior of a kyber cryptography circuit resulting in a behavior definition, the behavior of the kyber cryptography circuit including parallel butterfly operations with output of the parallel butterfly operations fedback directly to inputs of the parallelized butterfly operations;
a transcompiler configured to convert the behavior definition to a gate-level implementation resulting in a circuit definition; and
a logic synthesis tool configured to implement the circuit definition in hardware.

11. The system of claim 10, wherein the behavior definition includes the butterfly operations configured as Cooley-Tukey (CT) butterfly operations or Gentleman-Sande (GS) butterfly operations.

12. The system of claim 10, wherein the behavior definition further comprises before receiving the outputs, rearranging an order of the outputs to alter which of the butterfly operations receives one or more of the outputs.

13. The system of claim 10, wherein the behavior definition includes number theoretic transform (NTT) and inverse number theoretic transform (INTT).

14. The system of claim 13, wherein the behavior definition includes the butterfly operations as part of the NTT and the INTT.

15. The system of claim 14, wherein the behavior definition includes polynomial multiplication in an NTT domain with a polynomial that has n coefficients and there are n/2 butterfly operations.

16. The system of claim 10, wherein the behavior definition includes each butterfly operation receiving a first coefficient of a polynomial from a respective first register, a second coefficient of the polynomial from a respective second register, and a twiddle factor from a respective third register.

17. The system of claim 16, wherein the behavior definition includes selection, based on a select control, coefficients of a polynomial or the outputs of the butterfly operations.

18. The system of claim 12, wherein the behavior definition includes, in each butterfly operation, a selection, based on a select control, whether the butterfly operation is in NTT mode or INTT mode.

19. A non-transitory machine-readable medium including instructions that, when executed by a machine, cause the machine to perform operations comprising:
receiving, by a high-level programming language, a behavior definition of a kyber cryptography circuit, the behavior definition including parallel butterfly operations with output of the parallel butterfly operations fedback directly to inputs of the parallelized butterfly operations;
converting, by high-level synthesis (HLS), the behavior definition to a gate-level implementation resulting in a circuit definition; and
synthesizing the circuit definition in hardware.

20. The non-transitory machine-readable medium of claim 19, wherein the behavior definition includes polynomial multiplication in an NTT domain with a polynomial that has n coefficients and there are n/2 butterfly operations.
